(19) United States
(12) Patent Application Publication
(10) Pub. No.: US 2025/0044542 A1
(43) Pub. Date: Feb. 6, 2025

(54) LENS MODULE

(71) Applicant: SAMSUNG ELECTRO-MECHANICS CO., LTD., Suwon-si (KR)

(72) Inventors: Yeo Ok JEON, Suwon-si (KR); Ho Jae LEE, Suwon-si (KR); Se Yeon HWANG, Suwon-si (KR)

(73) Assignee: SAMSUNG ELECTRO-MECHANICS CO., LTD., Suwon-si (KR)

(21) Appl. No.: 18/440,877

(22) Filed: Feb. 13, 2024

(30) Foreign Application Priority Data
Aug. 4, 2023 (KR) 10-2023-0101935

(51) Int. Cl. G02B 7/02; G02B 7/10

(52) U.S. Cl. CPC G02B 7/023; G02B 7/021; G02B 7/026; G02B 7/10

(57) ABSTRACT

A lens module includes a lens barrel including a plurality of lenses arranged in a first direction, a zoom ring configured to accommodate the lens barrel, and a lens gap adjustment member coupled to the lens barrel and the zoom ring to adjust a gap between the plurality of lenses. The lens barrel and the zoom ring form a sliding groove extending in the first direction to guide a movement of the lens gap adjustment member. The sliding groove includes a serrated portion to which the lens gap adjustment member slidably engages in the first direction.

### CROSS-REFERENCE TO RELATED APPLICATIONS

This application claims the benefit under 35 USC 119(a) of Korean Patent Application No. 10-2023-0101935 filed on Aug. 4, 2023, in the Korean Intellectual Property Office, the entire disclosure of which is incorporated herein by reference for all purposes.

### 1. FIELD

The following description relates to a lens module.

### 2. DESCRIPTION OF THE BACKGROUND

Mixed reality that combines virtual and augmented reality is becoming more prominent.

Mixed reality reflects the real world and reduces the sense of difference a virtual world gives, allowing users to feel virtual images as if they are a portion of reality. Also, in addition to vision, various human senses, such as hearing and touch, may be combined with virtuality, thereby increasing liveliness and immersion.

Among display technologies, mixed reality is provided through a video see-through (VST) method, which mixes the real world imaged by a camera with virtual images.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens module includes a lens barrel including a plurality of lenses arranged in a first direction, a zoom ring configured to accommodate the lens barrel, and a lens gap adjustment member coupled to the lens barrel and the zoom ring to adjust a gap between the plurality of lenses. The lens barrel and the zoom ring form a sliding groove extending in the first direction to guide a movement of the lens gap adjustment member. The sliding groove includes a serrated portion to which the lens gap adjustment member slidably engages in the first direction.

The lens gap adjustment member may include a sliding portion movable in the first direction within the sliding groove. A bridge portion may have a side disposed on the sliding portion and another side disposed on the lens barrel to support a movement of the sliding portion.

The sliding portion may include a fixing protrusion coupled to the serrated portion. The sliding portion may be slidable in the first direction when the serrated portion and the fixing protrusion are misaligned, and fixed when the fixing protrusion is engaged with the serrated portion.

The lens barrel may include a fixed barrel, including at least one lens, and a movable barrel, including at least one lens, configured to move relative to the fixed barrel in the first direction. As the movable barrel moves, a gap between the at least one lens of the fixed barrel and the at least one lens of the movable barrel may change.

The bridge portion may include a first bridge portion extending upwardly from the sliding portion and disposed in the movable barrel, and a second bridge portion extending downwardly from the sliding portion and disposed in an accommodating groove formed in the fixed barrel.

An end of the first bridge portion may have plural bent portions.

The movable barrel may include a seating groove in an outer circumferential surface into which an end of the first bridge portion is inserted. The movable barrel may be moved in the first direction by the first bridge portion.

The second bridge portion may be configured to maintain contact with at least an inner wall portion of the accommodating groove when disposed in the accommodating groove.

The lens module may further include first and second ball members disposed between the lens barrel and the zoom ring to guide a movement of the zoom ring in the first direction.

The lens gap adjustment member and the first and second ball members may be disposed at angular intervals in a circumferential direction of the zoom ring and the lens barrel.

In another general aspect, a lens module includes a lens barrel including a plurality of lenses arranged in a first direction, a zoom ring configured to accommodate the lens barrel, and a lens gap adjustment member, coupled to the lens barrel and the zoom ring, configured to be movable in the first direction. The lens barrel includes a movable barrel, including a first lens group, and a fixed barrel, including a second lens group. The zoom ring and the movable barrel are configured to move, in a direction parallel to the first direction, together with the lens gap adjustment member.

The lens module may further include first and second ball members, disposed between the fixed barrel and the zoom ring, including a plurality of ball members disposed in the first direction.

The lens gap adjustment member and the first and second ball members may be disposed at angular intervals in a circumferential direction of the zoom ring and the lens barrel.

The fixed barrel and the zoom ring may form a sliding groove extending in the first direction to guide a movement of the lens gap adjustment member.

The lens gap adjustment member may include a sliding portion movable in the first direction within the sliding groove, and a bridge portion having a side disposed in the sliding portion and another side disposed in the lens barrel to support a movement of the sliding portion.

The sliding groove may include a serrated portion to which the lens gap adjustment member slidably engages in the first direction. The sliding portion may include a fixing protrusion coupled to the serrated portion.

Other features and aspects will be apparent from the following detailed description, the drawings, and the claims.

### BRIEF DESCRIPTION OF DRAWINGS

FIG. 1 is a perspective view of a camera module to which a lens module is applied.

FIG. 2 is an exploded perspective view of the camera module of FIG. 1.

FIG. 3 is a plan view of the camera module of FIG. 1.

FIG. 4 is a cross-sectional view taken in line I-l′ of FIG. 1.

FIG. 5 is an enlarged, exploded perspective view of region A of FIG. 4.

FIG. 6 is an enlarged view of the region A of FIG. 4 when a lens module is in an initial position.

FIG. 7 is an enlarged view of the region A of FIG. 4 when the lens module is in a maximally raised position.

FIG. 8 is a cross-sectional view taken in line II-II′ of FIG. 3.

FIG. 9 is an enlarged view of region B of FIG. 8 when the lens module is in the initial position.

FIG. 10 is an enlarged view of region B of FIG. 8 when the lens module is in a maximally raised position.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure.

For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

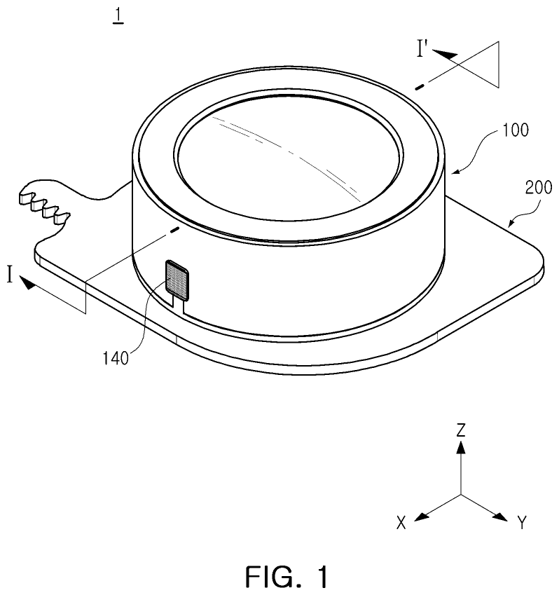

FIG. 1 is a perspective view of a camera module to which a lens module is applied.

A camera module 1 illustrated in FIG. 1 may be a camera module for video see-through (VST) that provides mixed reality. The camera module 1 may be mounted on a head mount device (HMD) worn by a user on the head.

The camera module 1 may include a lens module 100 and an image sensor module 200, according to an embodiment in the present disclosure. The lens module 100, according to an embodiment in the present disclosure, may be a pancake lens assembly with a low thickness.

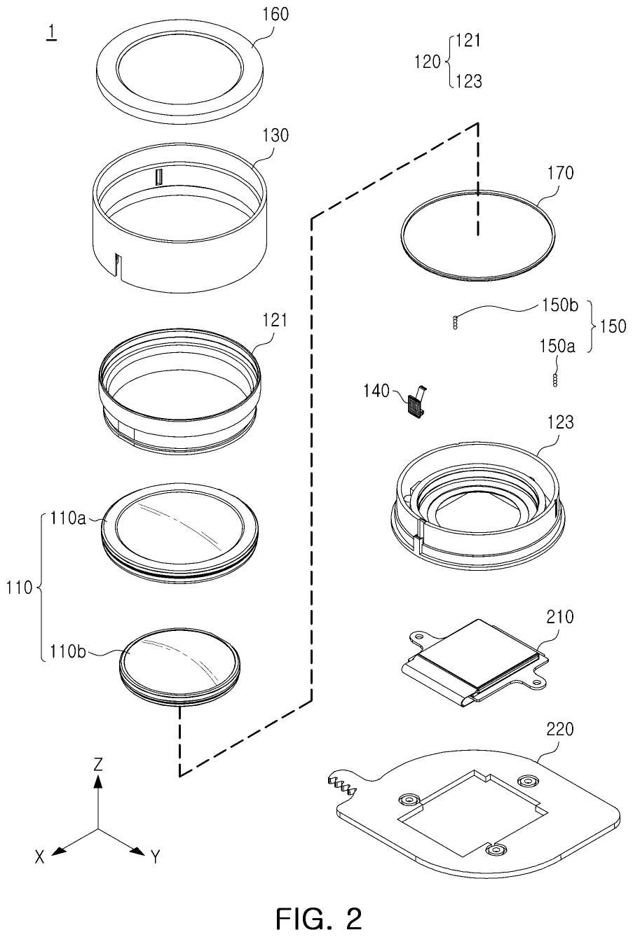

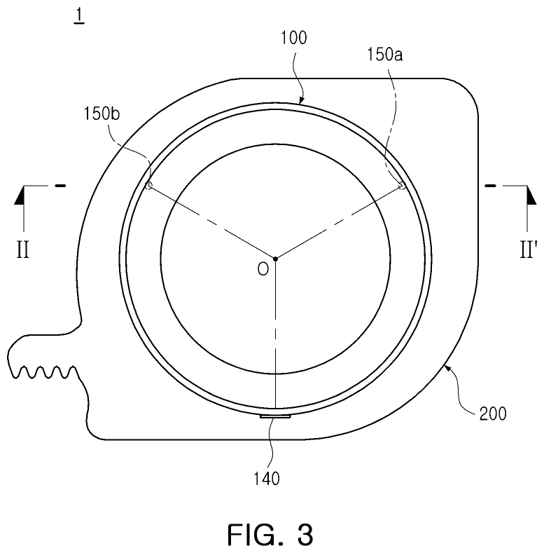

FIG. 2 is an exploded perspective view of the camera module of FIG. 1, and FIG. 3 is a plan view of the camera module of FIG. 1.

The lens module 100 and the image sensor module 200 may be arranged in a first direction (a Z-direction).

The lens module 100 may include a plurality of lenses 110, a lens barrel 120, a zoom ring 130, a lens gap adjustment member 140, a ball member 150, a cap 160, and a ring member 170.

The plurality of lenses 110 may be mounted in the lens barrel 120, and the lens barrel 120 may be accommodated in the zoom ring 130, and the focus may be adjusted by moving the zoom ring 130 in the first direction (the Z-direction). The zoom ring 130 may be moved in the first direction (the Z-direction) by the lens gap adjustment member 140 and the ball member 150. Referring to FIG. 3, the lens gap adjustment member 140 and the ball member 150 may be arranged at regular angular intervals in a circumferential direction of the lens module 100. In an embodiment, the ball member 150 may include a first ball member 150a and a second ball member 150b, and the lens gap adjustment member 140, the first ball member 150a, and the second ball member 150b may be arranged at intervals of approximately 120 degrees in the circumferential direction of the lens module 100.

The image sensor module 200 may be disposed below the lens module 100. The image sensor module 200 may include a sensor unit 210, including an image sensor and a substrate on which the image sensor is mounted, and a plate 220, to which the sensor unit 210 and the lens module 100 are coupled. The lens module 100 may be coupled to the plate 220 through a fixed barrel 123, which will be described below.

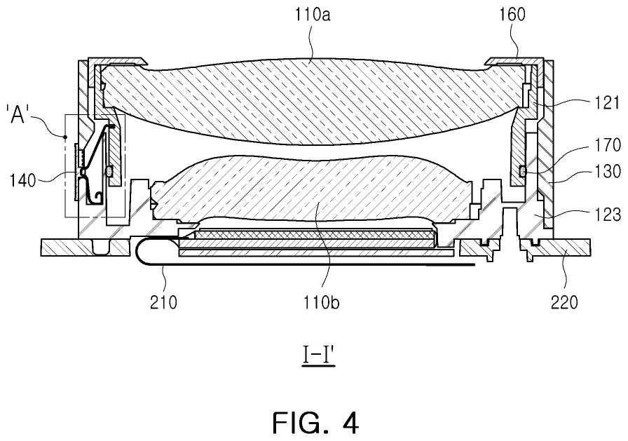

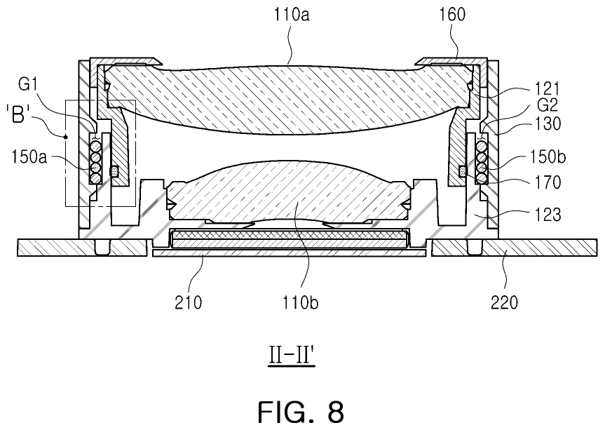

FIG. 4 is a cross-sectional view taken in line I-l′ of FIG. 1, and FIG. 8 is a cross-sectional view taken in line II-II′ of FIG. 3.

Referring to FIG. 4, the plurality of lenses 110 may be arranged in the first direction (the Z-direction). A direction in which the plurality of lenses 110 are arranged may be an optical axis direction. Although not illustrated in the drawing, a spacer may be disposed between the plurality of lenses 110.

The lens barrel 120 may include a movable barrel 121 and the fixed barrel 123, and the plurality of lenses 110 may be divided to be mounted on the movable barrel 121 and the fixed barrel 123. The plurality of lenses 110 may form a first lens group 110a and a second lens group 100b. The first lens group 110a may be mounted on the movable barrel 121, and the second lens group 110b may be mounted on the fixed barrel 123.

The movable barrel 121 may be moved relative to the fixed barrel 123 in the first direction (the Z-direction), while a portion of the movable barrel 121 is accommodated in the fixed barrel 123. At this time, the first lens group 110a mounted on the movable barrel 121 is also moved, relative to the second lens group 110b mounted on the fixed barrel 123 in the first direction (the Z-direction), so a gap between the first lens group 110a and the second lens group 110b may change and the focus may be adjusted. Meanwhile, the gap between the lenses mounted in the same lens barrel 120 may be constant.

The zoom ring 130 may have a cylindrical shape with a length in the first direction (the Z-direction) and may accommodate the lens barrel 120 therein. The zoom ring 130 may be moved in the first direction (the Z-direction) during focus adjustment, and the movable barrel 121 may be moved in conjunction with the movement of the zoom ring 130.

The zoom ring 130 may be moved in the first direction (the Z-direction) by the lens gap adjustment member 140 and the ball member 150. When an external force is applied to the lens gap adjustment member 140, the ball member 150 may perform a rolling movement that rises or falls in the first direction (the Z-direction) due to the external force.

In an embodiment, the lens gap adjustment member 140 may be a structure operated in a step-sliding manner. The lens gap adjustment member 140 may slide in the first direction (the Z-direction) when external force is applied, and may be fixed in a position at which the external force is removed. Accordingly, a reverse movement may be limited.

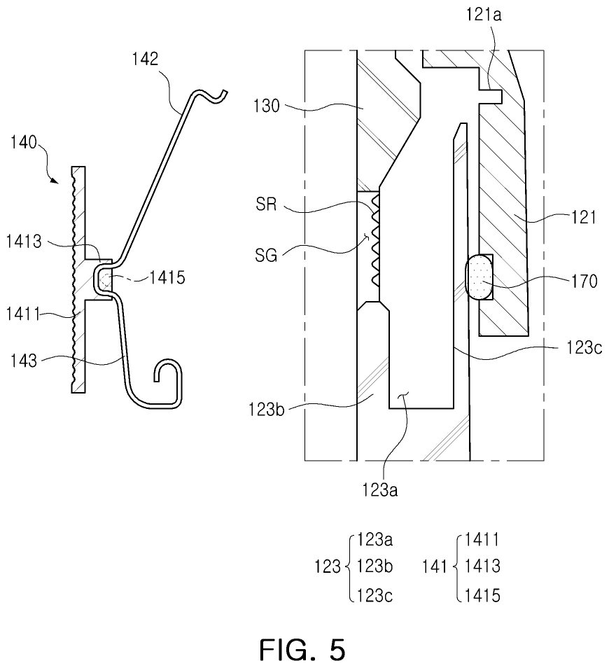

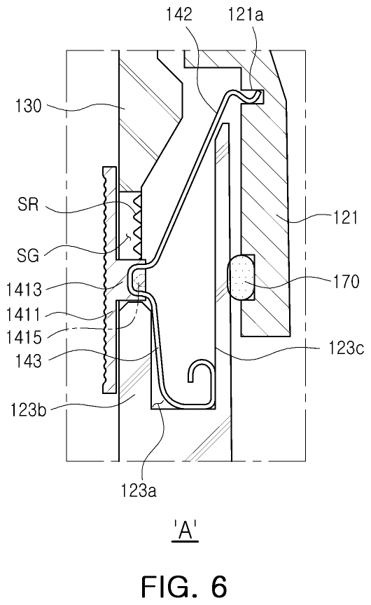

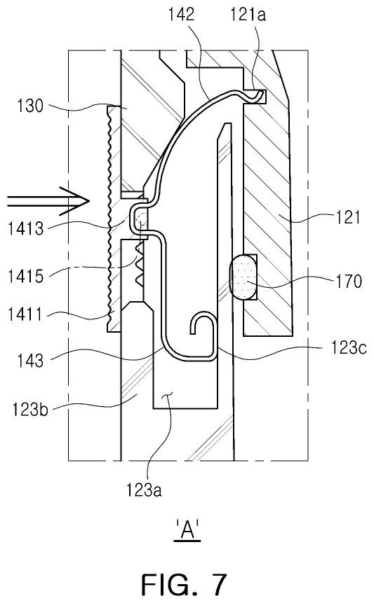

FIG. 5 is an enlarged exploded perspective view of region A of FIG. 4, FIG. 6 is an enlarged view of region A of FIG. 4 when the lens module is in an initial position, and FIG. 7 is an enlarged view of the region A of FIG. 4 when the lens module is in a maximally raised position.

In the following description, the initial position refers to a position at which the lens module 100 is lowered to the maximum (or the position at which a first bridge portion 142, which will be described below, is not bent). However, without being limited thereto, the initial position may be a certain position present between a position at which the lens module 100 is maximally lowered and a position at which the lens module 100 is maximally raised. For example, the initial position may refer to a position of the lens module 100 before focus adjustment.

The lens gap adjustment member 140 may include a sliding portion 141 movable in the first direction (the Z-direction) and bridge portions 142 and 143 supporting the movement of the sliding portion 141.

In addition, the sliding portion 141 may include an operating portion 1411 disposed outside a sliding groove SG, to which external force is applied, an insertion protrusion 1413 inserted into the sliding groove SG, and a fixing protrusion 1415 fixing the position.

When external force is applied to the sliding portion 141 (or the operating portion 1411), the sliding portion 141 may slide in the first direction (the Z-direction). In an embodiment, an external force may be applied in a direction perpendicular to the first direction (the Z-direction) and may be a force by which the user pushes the operating portion 1411 toward the center of the lens module 100. To this end, a fine gap may exist between an outer circumferential surface of the zoom ring 130 and the operating portion 1411 when the external force is removed.

The sliding portion 141 may be provided in the sliding groove SG formed by the zoom ring 130 and the fixed barrel 123. The sliding groove SG may have a length in the first direction (the Z-direction) and guide the movement of the sliding portion 141 in the first direction (the Z-direction).

The sliding groove SG may be formed by a first auxiliary groove 131 formed on the zoom ring 130 and a second auxiliary groove 1231 formed on the fixed barrel 123. The first auxiliary groove 131 may have a length in the first direction (the Z-direction) and may have an open lower end. The second auxiliary groove 1231 may have a length in the first direction (the Z-direction) and may have an open upper end. The sliding groove SG may be formed by aligning the open lower end of the first auxiliary groove 131 and the open upper end of the second auxiliary groove 1231 to face each other in the first direction (the Z-direction).

Meanwhile, a serrated portion SR having a constant pitch in a longitudinal direction may be provided in the sliding groove SG. The serrated portion SR may be formed to be adjacent to the zoom ring 130, that is, on the internal surfaces of the first auxiliary groove 131 facing each other.

A fixing protrusion 1415 may be a portion engaging with the serrated portion SR. The fixing protrusion 1415 may be provided on both sides of an insertion protrusion 1413 facing the internal surface of the first auxiliary groove 131. When external force is applied to the sliding portion 141, the fixing protrusion 1415 may be misaligned with the serrated portion SR, so that the sliding portion 141 may freely move up or down in the first direction (the Z-direction). In addition, when the external force is removed, and the movement of the sliding portion 141 is stopped, the fixing protrusion 1415 is engaged with the serrated portion SR, so the sliding portion 141 may be prevented from moving in the reverse direction. According to an embodiment, the lens gap adjustment device 140 may be fixed to the zoom ring 130 through the combination of the serrated portion SR and the fixing protrusion 1415 without a separate external force (e.g., electric power) to fix the lens. Through this structure, the lens gap may be stably fixed.

The bridge portions 142 and 143 may be provided on one side of the sliding portion 141. The bridge portions 142 and 143 may include a first bridge portion 142 extending upwardly from the sliding portion 141 and a second bridge portion 143 extending downwardly.

The end of the first bridge portion 142 may be disposed on the movable barrel 121. The movable barrel 121 may include a seating groove 121a on the upper side of the sliding groove SG in the first direction (the Z-direction), and the end of the first bridge portion 142 may be inserted into and disposed in the seating groove 121a. An approximate entirety of the second bridge portion 143 may be disposed on the fixed barrel 123. The fixed barrel 123 may include an accommodating groove 123a below the second auxiliary groove 1231, forming the sliding groove SG. The accommodating groove 123a may include an outer wall portion 123b, and a space in which the second bridge portion 143 is accommodated may be formed by the outer wall portion 123b. The second bridge portion 143 may extend to a lower side of the second auxiliary groove 1231 and may be inserted into and disposed in the accommodating groove 123a surrounded by the outer wall portion 123b.

The first and second bridge portions 142 and 143 may elastically support the movement of the sliding portion 141. Referring to FIGS. 6 and 7, while the sliding portion 141 rises in the first direction (the Z-direction) from the initial position, the end of the first bridge portion 142 may be maintained to be fixed to the seating groove 121a, and a portion between the sliding portion 141 and the end of the first bridge portion 142 may be deformed.

The first and second bridge portions 142 and 143 may elastically support the movement of the sliding portion 141. Referring to FIGS. 6 and 7, while the sliding portion 141 rises in the first direction (the Z-direction) from the initial position, the end of the first bridge portion 142 may be maintained to be fixed to the seating groove 121a, and a portion between the end of the first bridge portion 142 and the sliding portion 141 may be deformed. In addition, the end of the first bridge portion 142 may be bent so as not to be separated from the seating groove 121a due to the movement of the sliding portion 141 or the like. Preferably, the end of the first bridge portion 142 may be bent two or more times, and an upper edge of the seating groove 121a may contact a region between the two bent portions. Meanwhile, while the sliding portion 141 moves in the first direction (the Z-direction), the second bridge portion 143 inserted in the accommodating groove 123a may move up or down in the moving direction of the sliding portion 141. The second bridge portion 143 may be removed from contact with the outer wall portion 123b while the sliding portion 141 is moving and may come into contact with the outer wall portion 123b when the sliding portion 141 is fixed. The end of the second bridge portion 143 may be maintained to be supported on an inner wall portion 123c of the accommodating groove 123a facing the outer wall portion 123b.

The lens module 100, according to an embodiment in the present disclosure, may include a ball member 150 guiding the movement of the zoom ring 130 in the first direction (the Z-direction) in conjunction with the sliding of the lens gap adjustment member 140 in the first direction (the Z-direction). The ball member 150 may include a first ball member 150a spaced apart from the lens gap adjustment member 140 by approximately 120 degrees in a counterclockwise (or clockwise) direction and a second ball member 150b spaced apart from the lens gap adjustment member 140 by approximately 120 degrees in the counterclockwise (or clockwise) direction.

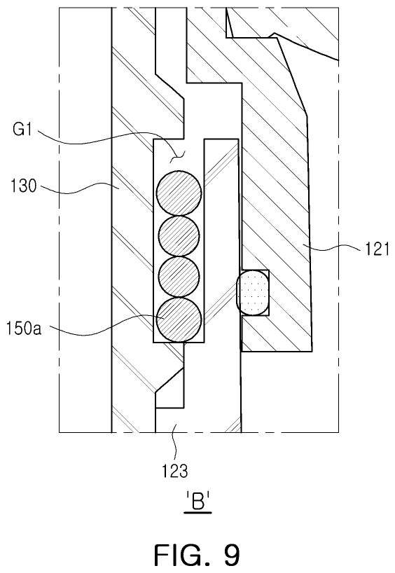

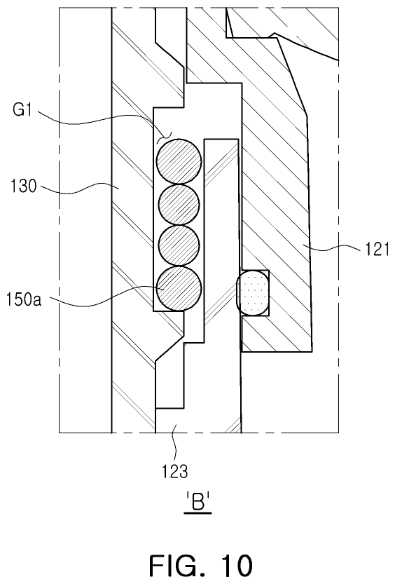

FIG. 9 is an enlarged view of region B of FIG. 8 when the lens module is in the initial position, and FIG. 10 is an enlarged view of the region B of FIG. 8 when the lens module is in a maximally raised position.

The first and second ball members 150a and 150b may each include a plurality of ball members arranged in the first direction (the Z-direction) and may be disposed between the zoom ring 130 and the fixed barrel 123.

The zoom ring 130 and the fixed barrel 123 may include guide grooves extending in the first direction (the Z-direction) on surfaces facing each other in a direction perpendicular to the first direction (the Z-direction). In an embodiment, the zoom ring 130 may include a guide groove on an inner circumferential surface facing the fixed barrel 123, and the fixed barrel 123 may include a guide groove on an outer circumferential surface facing the zoom ring 130 and opposing the guide groove formed in the zoom ring 130. The first ball member 150a and the second ball member 150b may be accommodated between the guide grooves formed by the zoom ring 130 and the fixed barrel 123. In an embodiment, the first ball member 150a may be accommodated in the first guide groove G1, and the second ball member 150b may be accommodated in the second guide groove G2.

When external force is applied to the lens gap adjustment member 140, the first and second ball members 150a and 150b may support the movement of the zoom ring 130 in the first direction (the Z-direction), while rolling in the first direction (the Z-direction) within the guide groove and move to the first position of the zoom ring 130. The zoom ring 130 may be moved in parallel in the first direction (the Z-direction) by the first and second ball members 150a and 150b.

The first and second ball members 150a and 150b may include a plurality of ball members with different diameters. In an embodiment, among the plurality of ball members, the outermost (the uppermost and the lowermost) ball members in the first direction (the Z-direction) may have a larger diameter than the ball members disposed therebetween. Accordingly, among the plurality of ball members of the first and second ball members 150 and 150b, only the outermost ball member is in contact with the guide groove so that the movement of the zoom ring 130 in the first direction (the Z-direction) may be guided smoothly.

In the accompanying drawings, the first and second ball members 150a and 150b are illustrated as including four ball members each, but a different number of ball members may be provided. Further, the first and second ball members 150a and 150b may include different numbers of ball members.

As described above, the lens module 100, according to an embodiment in the present disclosure, may adjust the focus by sliding the lens gap adjustment member 140 in the first direction (the Z-direction). During focus adjustment, the zoom ring 130 may also be moved in a direction parallel to the first direction (the Z-direction). In addition, fixation is possible between the lens gap adjustment member 140 and the zoom ring 130, so that the lens gap may be stably maintained after focus adjustment. Accordingly, constant resolution may be provided.

According to an embodiment in the present disclosure, the lens module may provide constant resolution without being affected by an external environment. In addition, focus may be adjusted at high speeds.

An aspect of the present disclosure is to provide a lens module in which a lens position is structurally fixed after focus adjustment.

Another aspect of the present disclosure is providing a lens module with a short moving distance during focus adjustment.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a lens barrel including a plurality of lenses arranged in a first direction;
a zoom ring accommodating the lens barrel; and
a lens gap adjustment member coupled to the lens barrel and the zoom ring to adjust a gap between the plurality of lenses,
wherein the lens barrel and the zoom ring form a sliding groove extending in the first direction to guide a movement of the lens gap adjustment member, and
wherein the sliding groove includes a serrated portion to which the lens gap adjustment member slidably engages in the first direction.

2. The lens module of claim 1, wherein the lens gap adjustment member includes a sliding portion movable in the first direction within the sliding groove, and
a bridge portion having a side disposed on the sliding portion and another side disposed on the lens barrel to support a movement of the sliding portion.

3. The lens module of claim 2, wherein the sliding portion includes a fixing protrusion coupled to the serrated portion, and
the sliding portion is slidable in the first direction when the serrated portion and the fixing protrusion are misaligned, and fixed when the fixing protrusion is engaged with the serrated portion.

4. The lens module of claim 2, wherein the lens barrel includes
a fixed barrel including at least one lens, and
a movable barrel, including at least one lens, configured to move relative to the fixed barrel in the first direction, and
wherein, as the movable barrel moves, a gap between the at least one lens of the fixed barrel and the at least one lens of the movable barrel changes.

5. The lens module of claim 4, wherein the bridge portion includes
a first bridge portion extending upwardly from the sliding portion and disposed in the movable barrel, and
a second bridge portion extending downwardly from the sliding portion and disposed in an accommodating groove formed in the fixed barrel.

6. The lens module of claim 5, wherein an end of the first bridge portion has plural bent portions.

7. The lens module of claim 5, wherein the movable barrel includes a seating groove in an outer circumferential surface into which an end of the first bridge portion is inserted, and
the movable barrel is moved in the first direction by the first bridge portion.

8. The lens module of claim 5, wherein the second bridge portion is configured to maintain contact with at least an inner wall portion of the accommodating groove when disposed in the accommodating groove.

9. The lens module of claim 1, further comprising first and second ball members disposed between the lens barrel and the zoom ring to guide a movement of the zoom ring in the first direction.

10. The lens module of claim 9, wherein the lens gap adjustment member and the first and second ball members are disposed at angular intervals in a circumferential direction of the zoom ring and the lens barrel.

11. A lens module comprising:
a lens barrel including a plurality of lenses arranged in a first direction;
a zoom ring accommodating the lens barrel; and
a lens gap adjustment member, coupled to the lens barrel and the zoom ring, configured to be movable in the first direction,
wherein the lens barrel includes a movable barrel, including a first lens group, and a fixed barrel, including a second lens group, and
the zoom ring and the movable barrel are configured to move, in a direction parallel to the first direction, together with the lens gap adjustment member.

12. The lens module of claim 11, further comprising first and second ball members, disposed between the fixed barrel and the zoom ring, including a plurality of ball members disposed in the first direction.

13. The lens module of claim 12, wherein the lens gap adjustment member and the first and second ball members are disposed at angular intervals in a circumferential direction of the zoom ring and the lens barrel.

14. The lens module of claim 11, wherein the fixed barrel and the zoom ring form a sliding groove extending in the first direction to guide a movement of the lens gap adjustment member.

15. The lens module of claim 14, wherein the lens gap adjustment member includes
a sliding portion movable in the first direction within the sliding groove, and
a bridge portion having a side disposed in the sliding portion and another side disposed in the lens barrel to support a movement of the sliding portion.

16. The lens module of claim 14, wherein the sliding groove includes a serrated portion to which the lens gap adjustment member slidably engages in the first direction, and
the sliding portion includes a fixing protrusion coupled to the serrated portion.
